(19) United States
(12) Patent Application Publication
(10) Pub. No.: US 2009/0232959 A1
(43) Pub. Date: Sep. 17, 2009

(54) High pressure meat product processing

(75) Inventor: David R. McKenna, Benton, KS (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/381,544

(22) Filed: Mar. 13, 2009

Related U.S. Application Data
(60) Provisional application No. 61/069,231, filed on Mar. 13, 2008.

(51) Int. Cl. A23L 1/318; A23L 1/31

(52) U.S. Cl. 426/641; 426/392

(57) ABSTRACT

Processes that utilize one or more pressurization and depressurization treatments to tenderize fresh cuts of meat are described.

### CROSS REFERENCE TO RELATED APPLICATIONS

This application claims the benefit of U.S. Provisional application Ser. No. 61/069,231 filed Mar. 13, 2008, entitled “THE USE OF CYCLICAL PRESSURIZATION/DEPRESSURIZATION AS A TENDERIZATION METHOD FOR FRESH MEAT,” which is hereby incorporated by reference in its entirety.

### TECHNICAL FIELD

The processing methods described herein relate to techniques for processing meat with high hydrostatic pressure (HHP).

### BACKGROUND

Tenderness is a quality attribute that affects market price and consumer acceptance of meat products. There are several methods for improving meat tenderness, including mechanical tenderization, elevated temperature storage, calcium chloride injection, electrical stimulation, muscle stretching, shock-wave pressure, dry and wet aging, and enzymatic treatment. In all methods, however, there are potentially sensory, technical, or food safety drawbacks that could make such processing systems less advantageous. Natural proteases derived from plants (i.e., bromelain, ficin, and papain, for example) have been used as enzymatic tenderizers; however, their action can be difficult to control and can alter the texture of muscle in a negative way. These enzymes, however, have very broad specificities and therefore hydrolyze indiscriminately the major meat proteins (connective tissue/collagen and myofibrillar proteins) resulting in an over-tenderized (i.e., mushy) product. Furthermore, papain, which is the most widely used, is relatively heat-stable, allowing uncontrolled texture deterioration during and after cooking. Mechanical tenderization systems (i.e., blade or needle tenderization) have garnered widespread use throughout the industry. Brine injection has become increasingly more widespread, however, the finished product has different palatability characteristics than non-injected cuts of meat.

As an additional concern, meat products are inevitably exposed to microbes in the course of processing or in the course of handling prior to processing. Microbes are part of the natural decay process of organic material and may be deposited on meat products through the air or by contact between the meat products and contaminated equipment or other material. Although some microbes may be relatively benign, others may be generally undesirable. Lactic acid producing bacteria are examples of benign microbes, while some strains of E. Coli, Salmonella, Listeria, and Staph bacteria are examples of pathogenic microbes which are generally undesirable.

### SUMMARY

The processes described herein utilize one or more pressurization and depressurization treatments to tenderize fresh cuts of meat. Application of pressure with subsequent depressurization can be achieved using high hydrostatic pressure. Application of depressurization followed by pressurization can be achieved using pumps or the like. Utilizing one or more of these processes, it is possible to tenderize cuts of meat in a non-invasive manner by causing one or both of physical disruption of structural proteins within muscle and by increasing the activity of calpain present in the muscle tissue. Moreover, tenderizing fresh meat with one or more pressurization and depressurization treatments avoids the need to contact the meat with blades or needles such as are used in mechanical tenderization processes.

In an aspect of the present invention, a method for tenderizing fresh meat is provided. The method comprises providing fresh meat; vacuum packaging the fresh meat; applying hydrostatic pressure between about 1000 psi and about 39,000 psi to the fresh meat; and depressurizing the fresh meat. The exemplary method preferably comprises applying hydrostatic pressure between about 10,000 psi and about 15,000 psi to the fresh meat. More preferably, the method comprises applying hydrostatic pressure of about 12,000 psi to the fresh meat.

In another aspect of the present invention, a method for tenderizing fresh meat is provided. The method comprises providing fresh meat comprising one or more fresh beef strip loin steaks and fresh beef top sirloin steaks; vacuum packaging the fresh meat; applying hydrostatic pressure between about 1000 psi and about 39,000 psi to the fresh meat; and depressurizing the fresh meat. The exemplary method preferably comprises applying hydrostatic pressure between about 10,000 psi and about 15,000 psi to the fresh meat. More preferably, the method comprises applying hydrostatic pressure of about 12,000 psi to the fresh meat.

### BRIEF DESCRIPTION OF THE DRAWINGS

The above mentioned and other advantages of the processes described herein, and the manner of attaining them, will become more apparent and the processes will be better understood by reference to the following description of the embodiments taken in conjunction with the accompanying drawings, wherein:

FIG. 1 is a graph showing an exemplary relationship between high pressure processing described herein and slice-shear force values for beef strip loin steaks.

FIG. 2 is a graph showing an exemplary relationship between high pressure processing described herein and slice-shear force values for top sirloin steaks.

FIG. 3 is a table showing exemplary slice-shear force values for control, strip loin steaks, and sirloin steaks processed at an exemplary pressure of 275 mPa (40,000 psi).

FIG. 4 is a flowchart showing an exemplary process for tenderizing meat with high hydrostatic pressure.

### DETAILED DESCRIPTION

The embodiments described herein are not intended to be exhaustive or to limit the embodiments to the precise forms disclosed in the following detailed description. Rather the embodiments are chosen and described so that others skilled in the art may appreciate and understand the principles and practices of the processes described herein.

The use of HHP has been investigated in fresh and processed meat; however, the existing research is directed to HHP as a microbial intervention. Some research has also been performed with heated-HHP applications where the finished product is fully cooked. See Bouton, P. E., Ford, A. L., Harris, P. V., Macfarlane, J. J., O'Shea, J. M. Pressure-heat treatment of post rigor muscle: Effects on tenderness. Journal of Food Science. 1977a;42(1):132-135. Bouton, P. E., Harris, P. V., Macfarlane, J. J., O'Shea, J. M. Effect of pressure treatments on the mechanical properties of pre- and post-rigor meat. Meat Science. 1977b;1(4):307-318. Bouton, P. E., Harris, P. V., Macfarlane, J. J., O'Shea, J. M., Smith, M. B. Pressure-heat treatment of meat: Effect on connective tissue. Journal of Food Science. 1978;43(2):301-326. HHP has not been used to improve tenderness of fresh (uncooked, not frozen) meat and/or as a palatability enhancing process.

It has been discovered, as described herein, that high hydrostatic pressure (HHP) can be utilized to tenderize meat products. Generally, HHP functions by affecting the cell walls of microorganisms. Specifically, HHP causes conformational shifts in the constituents of cell walls, so that when pressure is released, cell constituents are unable to return to their normal conformation without interfering with other constituents. Changes result in either the cell rupturing or the formation of holes in the cell wall. Thus, rapid changes in pressure drive many changes on the cellular level. Accordingly, because HHP functions at the cellular level, HHP can affect the structure of muscle cells. As discovered and described herein, HHP can be used for improving meat tenderness and palatability because the structure of muscle cells is primarily governed by connective tissue and that the connective tissue component of muscle is a major impediment to tenderness in meat.

Generally, HHP refers to hydrostatic pressure in the range of about 1000 psi to about 100,000 psi. Preferably, in accordance with the present invention, pressure below about 39,000 psi is used to avoid denaturing of the color pigment in muscle that may cause a “white/opaque” appearance. Also, it is believed that at pressures above about 15,000 psi it is possible to deactivate the calpain-enzyme believed responsible for postmortem tenderization and processing pressures are determined accordingly. It is noted, however, that any pressure that functions to provide an improvement in tenderness can be used in accordance with the present invention.

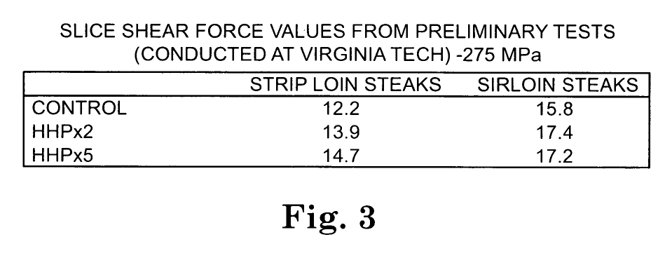

In one experiment, a HHP of 275 mPa (40,000 psi) was used to minimize the amount of discoloration that would form via the pressure-induced denaturation of myoglobin, while maximizing the change in pressure upon depressurization. In this experiment, steaks were pressurized to 275 mPa and immediately depressurized. In one batch this cycle was repeated two times and in another batch it was repeated five times. Results from that study are provided in FIG. 3 and show that these HHP treated strip and sirloin steaks were tougher than control steaks, however, the data also indicates that HHP treated steaks did not undergo any proteolytic degradation from day 7 to day 14. Based on that data, it was believed that HHP had inactivated η-calpain thus negating any additional postmortem aging. Recently, Chéret et al. (2007) reported that calpain activity in fish muscle decreased when HHP was in excess of 100 mPa (14,500 psi) and completely stopped when HHP exceeded 300 mPa (43,500 psi). Thus, according to this experiment and the work of Chéret et al. one would not expect HHP to provide an improved tenderization function because of the reported decrease in calpain activity.

It has been discovered, however, that HHP can be used to tenderize fresh meat. For purposes of this disclosure, the term fresh meat means meat that is uncooked and not frozen at the time of HHP processing. Fresh meat does include meat that has been frozen and thawed and is pressure processed in thawed or semi-thawed state. Fresh meat can come from any desired animal and may comprise beef, pork, lamb, poultry, and fish, for example. Fresh meat may be provided in any desired cuts including the entire animal carcass or carcass portion such as primal, subprimal, and related cuts such as steaks and roasts and the like.

While not wishing to be bound by theory, it is believed that HHP cause cooperative action between physical disruption of muscle fibers and enzymatic action of calpain. It is believed that HHP increases the activity of calpain thus making tenderization more effective. However, it is also believed that at some high-pressure limit calpain activity decreases and/or stops. Accordingly, optimized HHP processing parameters can be determined experimentally by monitoring calpain activity and/or measuring improvements in tenderness of processed meat by measuring tenderness related characteristics such as slice-shear force values. Processing parameters are chosen to preserve appropriate calpain activity.

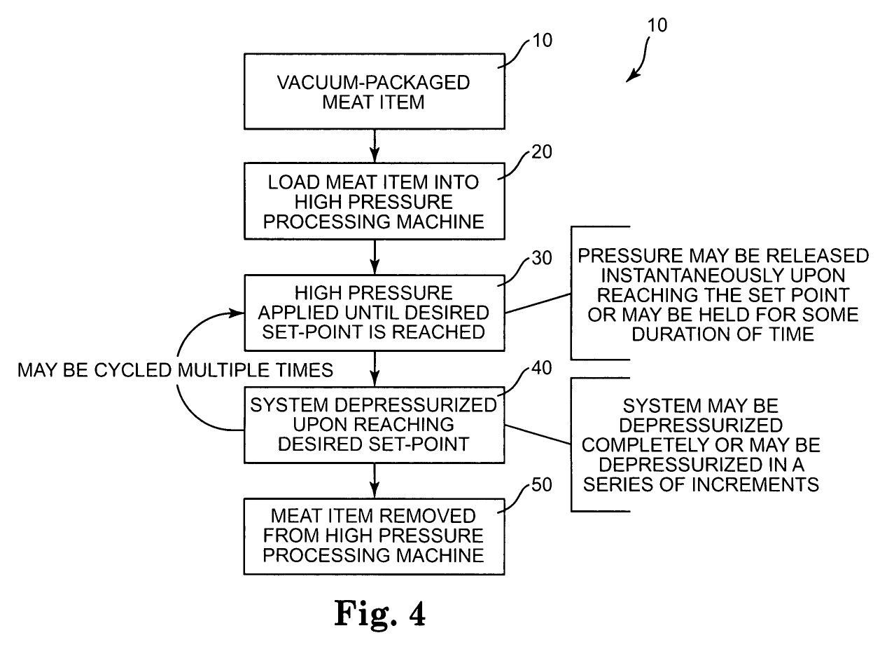

An exemplary process 10 that can be used to treat fresh meat with HHP is shown in the flowchart of FIG. 4. At step 20 a fresh meat product is vacuum packaged. Exemplary vacuum packaging equipment is available from Sealed Air of Elmwood Park, N.J. and Multivac USA of Kansas City, Mo. Exemplary Sealed Air processing systems include model numbers 8800E, 8610-14, 8610T-14E, and 8600. Exemplary Multivac processing systems include model numbers R125, R145, R245, and R535. Primals and subprimals are typically vacuum-packaged on Cryovac rotary systems. Steaks and roasts may be vacuum-packaged the same as subprimals, however, most consumer ready steaks and roasts are vacuum-packaged in a thermoformed pouch.

At step 30 the vacuum packaged meat product is loaded into a high pressure processing machine. Exemplary high-pressure processing machines are available from NC Hyperbaric of Burgos Spain and Avure Technologies Inc of Kent, Wash. Exemplary NC Hyperbaric processing systems include model numbers Wave 6000/55, Wave 6000/135, Wave 6000/420, Wave 6000/300, and Wave 6000/300T. Exemplary Avure processing systems include model numbers 35L-600, 215L-600, 320L-400, 350L-600, and 687L-300.

The vacuum packaged meat product may be at any desired temperature when the meat product is vacuum packaged.

At pressurization step 40 high hydrostatic pressure is applied to the vacuum packaged meat product until a desired upper high-pressure set point is reached which can be held for any desired dwell time or immediately released. Preferably, pressure in the range from about 1000 psi to about 39,000 psi is used. More preferably, pressure in the range from about 10,000 to about 15,000 psi is used. In a particularly preferred process a pressure of about 12,000 psi is used as described below. Any pressure that provides an improvement in tenderness can be used. Repeated cyclical application of pressure followed by immediate depressurization is one preferred process but application of pressure that is held for a desired dwell time may also be used alone or in combination with repeated cyclical pressurization and depressurization. Any desired ramp rate can be used to achieve the upper high-pressure set point including one or more ramps to an intermediate pressure with a dwell and/or one or more pressurization and depressurization cycles. Once the upper high pressure set point is reached, a depressurization step 50 is performed where the pressure may be released instantaneously and returned to atmospheric pressure (or some intermediate pressure) or may be held a the high pressure set point for any desired dwell time (1-10 seconds, for example). Pressure may released in any desired stages, ramps, and/or increments as desired and may be combined with depressurization and repressurization cycles and may include any desired dwell or hold times. Any depressurization ramp rate(s) can be used. Pressurization and depressurization cycles (including a return to atmospheric pressure) may be repeated for as many cycles as desired to achieve desired results. The vacuum packaged meat product may be at any desired temperature when the meat product is pressure processed. When the meat product is finally returned to atmospheric pressure the meat product is removed from the high pressure processing machine at step 50.

In an exemplary embodiment the fresh meat is processed to achieve a 5% or more reduction in slice-shear force value (1 kgf reduction in a product with a 20 kgf baseline, for, example). In another exemplary embodiment the fresh meat is processed to achieve a 10% or more reduction in slice shear force value. In another exemplary embodiment the fresh meat is processed to achieve a 15% or more reduction in slice shear force value.

### EXAMPLES

### 1. Raw Material Processing

USDA Select beef, boneless, strip loins (IMPS 180; n=6) and beef, boneless, top sirloin butts (IMPS 184; n=5) were procured. Strips were trimmed of external fat according to standard industry practices and then portioned into 2.5 cm-thick steaks using an automated portioning system (XL350, Marel Food System, Lenexa, Kans.). Six steaks were collected from each strip loin and assigned randomly to one of six treatments. Steaks were vacuum-packaged individually and placed in cold storage (1° C.) until HHP processing.

Top sirloin butts were processed so the M. biceps femoris (i.e., coulotte) and the M. gluteus intermedius (i.e., mouse muscle) were removed so only the M. gluteus medius muscle was used in the study. Sirloins were hand-cut into 2.5 cm-thick steaks by cutting across the grain of the muscle fibers starting on the caudal end of each piece. Six steaks were derived from each sirloin and assigned randomly to one of six treatments. Steaks were vacuum-packaged individually and placed in cold storage (1° C.) until HHP processing.

### 2. HHP Processing

HHP processing was performed at the American Pasteurization Company facility in Milwaukee, Wis. Steaks were maintained fresh and shipped overnight for HHP processing. This exemplary HHP processing included subjecting steaks to 85 mPa (12,000 psi) of pressure, followed by immediate depressurization. This cycle was repeated 2-times for one treatment and 5-times for the other HHP treatment. Steak samples were return-shipped overnight after the HHP processing. Upon arrival, strip steak samples had 15 days of age and sirloin steak samples had 17 days of age. Steaks assigned to treatments designating fewer days of age were frozen immediately. The remaining strip steaks were stored in a cooler (1° C.) until they reached 21 days of age and were then frozen. Likewise, the remaining sirloin steaks were stored in a cooler (1° C.) until they reached 30 days of age and were then frozen.

### 3. Slice-Shear Force (SSF) Determination

Steaks were evaluated for objective tenderness using the slice-shear methodology developed by the USDA-MARC located in Clay Center, Nebr. Briefly, steaks were removed from the freezer and allowed to thaw a minimum of 24 hrs. Steaks were cooked in an impingement oven until they reached an internal temperature of 71° C. and then slice-shear evaluations were performed. A single slice shear was evaluated from strip steaks, whereas, 3 slice shear evaluations were performed on sirloin steaks. Results were recorded as kg of force (kgf).

### 4. Statistical Analysis

The study included a factorial design having 3 HHP treatments (Control; HHP-2 cycles; HHP-5 cycles) and 2 aging scenarios (strips: 15 & 21-days; sirloins: 17 & 30-days). Data were analyzed using ANOVA (JMP 7.0, SAS Institute, Cary, N.C.) with cooking loss included as a covariate in the model. An α-level of 0.05 was used to determine significance and means were separated using Tukey's.

### 5. Results and Discussion

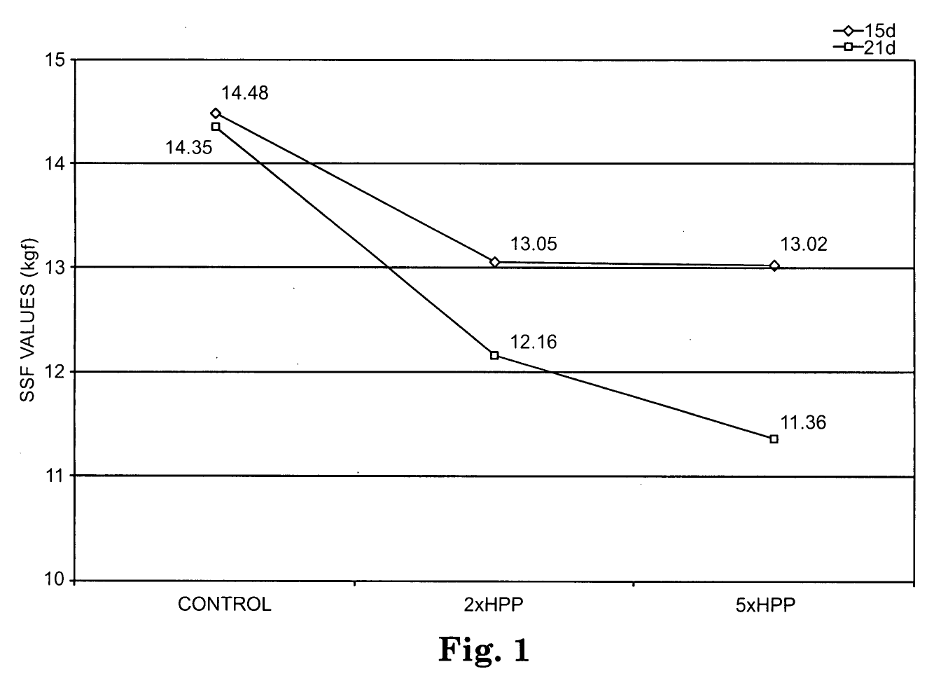

SSF values for beef strip loin steaks processed by the exemplary process described above are shown in FIG. 1. Data indicates that mean SSF values for control, 15-day, and 21-day aged strip loin steaks were similar. This was not unexpected because it is generally accepted that a majority of the aging response in strip loins occurs within the first 14-day postmortem.

Mean SSF values for HHP-treated steaks were numerically lower than control strip loin steaks regardless of treatment or age. Generally, SSF values between control strip loin steaks and HHP treated strip loin steaks were large enough (i.e., 1.5-3.0 kgf) that consumers could detect discernable differences.

A point of interest that is congruent with the previous observations involves looking at the aging response. While not being bound by theory, we speculate that the difference in SSF values between control/15-day aged strip loin steaks and HHP-treated/15-day aged strip loin steaks can only be attributed to HHP because steaks were frozen approximately 1-day after HHP processing. As previously mentioned, little additional aging occurred in control strip loin steaks aged 21-days compared to control strip loin steaks aged 15-days, however, it appeared that HHP-treated strip loin steaks aged to 21-days did undergo some form of additional/enhanced aging. Chéret et al. (2007) noted that in fish muscle treated with 100 mPa of HHP or less, calpain activity was enhanced through 4-d post-HHP treatment before dissipating. As such, and not desiring to be bound by theory, it is believed that HHP treatment can increase and/or enhance calpain functionality in postmortem meat muscle.

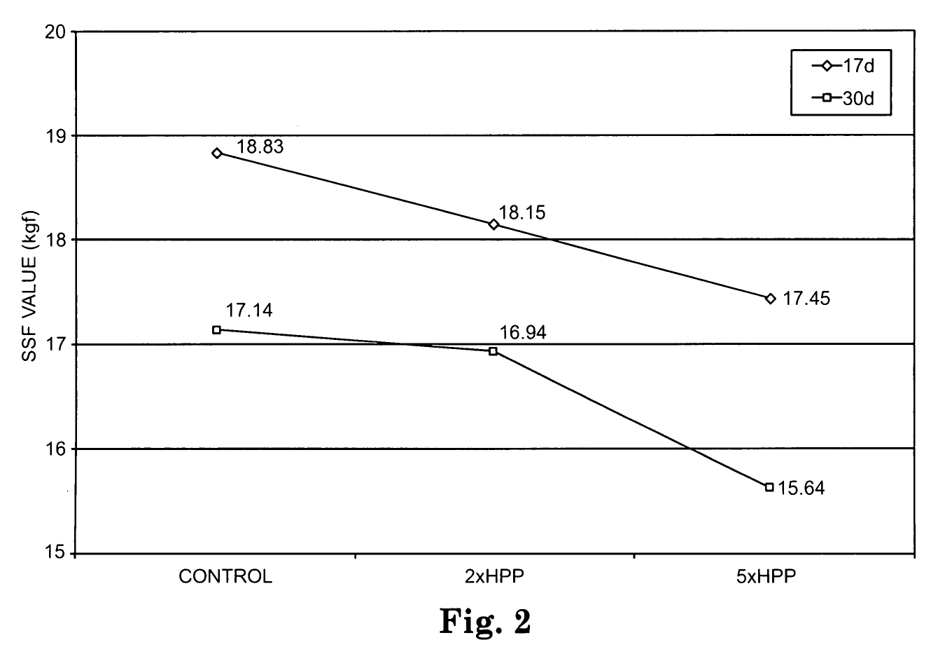

SSF values for top sirloin steaks processed by the exemplary process described above are shown in FIG. 2. As shown, additional aging resulted in lower SSF values for top sirloin steaks. Regardless of age, HHP appeared to induce a similar reduction in SSF values. As previously mentioned for strip loin steaks, the differences in SSF values between control sirloin steaks and HHP×5-treated sirloin steaks (i.e., 1.3-1.5 kgf) are believed to be detectable by consumers.

HHP processing may also help reduce tenderness variation within a subprimal cut. Muscles are typically variable in terms of tenderness (some more so than other—strip loins are less variable whereas top sirloins are highly variable in tenderness), such that one steak from a subprimal may be very tender, however, the adjacent steak may be much tougher. Likewise, such variation may be present within a steak such that one portion of a steak is very tender, while the opposite end may be very tough. HHP processing can advantageously reduce the tenderness variation within a muscle such as by pressure processing subprimal cuts.

Processes for high pressure meat processing are also described in U.S. Provisional Application Ser. No. 61/069,231, filed on Mar. 13, 2008, the entire disclosure of which is incorporated by reference herein for all purposes.

The processes described herein have now been described with reference to several embodiments thereof. The entire disclosure of any patent or patent application identified herein is hereby incorporated by reference for all purposes. The foregoing detailed description and examples have been given for clarity of understanding only. No unnecessary limitations are to be understood therefrom. It will be apparent to those skilled in the art that many changes can be made in the embodiments described without departing from the scope of the processes described herein. Thus, the scope of the processes described herein should not be limited to the processes described herein, but only by the processes described by the language of the claims and the equivalents of those processes.

What is claimed is:

1. A method for tenderizing fresh meat comprising;
providing fresh meat;
vacuum packaging the fresh meat;
applying hydrostatic pressure between about 1000 psi and about 39,000 psi to the fresh meat; and
depressurizing the fresh meat.

2. The method of claim 1, comprising applying hydrostatic pressure between about 10,000 psi and about 15,000 psi to the fresh meat.

3. The method of claim 1, comprising applying hydrostatic pressure of about 12,000 psi to the fresh meat.

4. The method of claim 1, comprising repeating the steps of applying and depressurizing at least once.

5. The method of claim 1, comprising holding the applied hydrostatic pressure for a predetermined period of time.

6. The method of claim 1, further comprising measuring a reduction in slice-shear force value for the fresh meat.

7. The method of claim 6, wherein the reduction in slice-shear force value is greater than five percent.

8. The method of claim 6, wherein the reduction in slice-shear force value is greater than fifteen percent.

9. The method of claim 1, wherein the fresh meat comprises one of more of primal cuts and subprimal cuts.

10. The method of claim 9, wherein the fresh meat comprises one of more of rounds, loins, ribs, chucks, steaks and roasts.

11. The method of claim 10, wherein the fresh meat comprises one of more of beef strip loin steaks and top sirloin steaks.

12. A tenderized meat product made by the process of claim 1, wherein the tenderized meat product has a slice-shear force value that has been reduced by at least five percent as compared to the slice-shear force value of the meat product before being treated by the process of claim 1.

13. A tenderized meat product made by the process of claim 1, wherein the tenderized meat product has a slice-shear force value that has been reduced by at least ten percent as compared to the slice-shear force value of the meat product before being treated by the process of claim 1.

14. A tenderized meat product made by the process of claim 1, wherein the tenderized meat product has a slice-shear force value that has been reduced by at least fifteen percent as compared to the slice-shear force value of the meat product before being treated by the process of claim 1.

15. A method for tenderizing fresh meat comprising:
providing fresh meat comprising one or more fresh beef strip loin steaks and fresh beef top sirloin steaks;
vacuum packaging the fresh meat;
applying hydrostatic pressure between about 1000 psi and about 39,000 psi to the fresh meat; and
depressurizing the fresh meat.

16. The method of claim 15, comprising applying hydrostatic pressure between about 10,000 psi and about 15,000 psi to the fresh meat.

17. The method of claim 15, comprising applying hydrostatic pressure of about 12,000 psi to the fresh meat.

18. The method of claim 15, comprising repeating the steps of applying and depressurizing at least once.

19. The method of claim 15, comprising repeating the steps of applying and depressurizing at least four times.

20. The method of claim 15, comprising reducing the slice-shear force value of the fresh meat by at least five percent as compared to the slice-shear force value of the fresh meat before being treated with high hydrostatic pressure.
